(19) United States
(12) Patent Application Publication
(10) Pub. No.: US 2025/0307510 A1
(43) Pub. Date: Oct. 2, 2025

(54) METHODS FOR SIMULATING ATOMIC STRUCTURES IN SEMICONDUCTOR MANUFACTURING PROCESS

(71) Applicant: TAIWAN SEMICONDUCTOR MANUFACTURING COMPANY LTD., HSINCHU (TW)

(72) Inventors: QING SHI, HSINCHU (TW); NUO XU, MILPITAS, CA (US); ZHI-REN XIAO, HSINCHU COUNTY (TW); ZHIQIANG WU, HSINCHU COUNTY (TW)

(21) Appl. No.: 18/619,235

(22) Filed: Mar. 28, 2024

(51) Int. Cl. G06F 30/3308

(52) U.S. Cl. CPC G06F 30/3308

(57) ABSTRACT

A method for simulating atomic structures in semiconductor manufacturing process is provided. The method includes the following operations. A first semiconductor structure data is received. The first semiconductor structure data comprises an atomic level information of each atom in a semiconductor structure. A second semiconductor structure data is generated by processing the first semiconductor structure data to obtain an expect atomic displacement of each atom in the semiconductor structure in a simulated ion implantation process. A third semiconductor structure data is generated by processing the second semiconductor structure data to obtain an expect atomic diffusion of each atom in the semiconductor structure in a simulated thermal annealing process.

### BACKGROUND

Ion implantation is a process in the manufacturing of semiconductor devices that provides a controlled method of changing electrical characteristics of selected regions within a semiconductor device. Ion implantation uses an ion implanter to generate ions of a nominal dopant and then accelerates the ions to an appropriate energy level. Once accelerated, the ions are transported by the ion implanter along an ion beam to impact and implant into selected regions of a semiconductor wafer.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 illustrates a flow of simulating atomic structures in a semiconductor manufacturing process according to some embodiment of the present disclosure.

FIG. 2 illustrates a flow chart of a method for simulating atomic structures in a semiconductor manufacturing process according to some embodiments of the present disclosure.

FIG. 3 illustrates a flow of the work of the amorphization model and the architecture according to some embodiments of the present disclosure.

FIG. 4 illustrates a flow chart of a process of generating the second semiconductor structure data by processing the first semiconductor structure data through an amorphization model according to some embodiments of the present disclosure.

FIG. 5 illustrates a total vacancy distribution along z direction in some examples provided by SRIM program.

FIG. 6 illustrates a flow of the work of the thermal diffusion model according to some embodiments of the present disclosure.

FIG. 7 illustrates a flow chart of a process of generating the third semiconductor structure data by processing the second semiconductor structure data through the thermal diffusion model according to some embodiments of the present disclosure.

FIG. 8A illustrates a schematic diagram of a semiconductor structure from a cross-sectional view perspective according to some embodiments of the present disclosure.

FIG. 8B illustrates a digital simulation image of a semiconductor structure from a cross-sectional view perspective according to some embodiments of the present disclosure.

FIG. 9 illustrates three digital simulation image examples to visually describe the difference between the three semiconductor structure data according to some embodiments of the present disclosure.

FIG. 10A illustrates a digital simulation image examples to show the thickness of an amorphous region according to some embodiments of the present disclosure.

FIG. 10B illustrates simulation data and experimental data according to some embodiments of the present disclosure.

### DETAILED DESCRIPTION

The following disclosure provides many different embodiments, or examples, for implementing distinctive features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the numerous examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer, or section from another. The terms such as “first”, “second”, and “third” when used herein do not imply a sequence or order unless clearly indicated by the context.

Ion implantation is a technique utilized in semiconductor manufacturing processes to modify the electrical properties of a target material, typically a silicon wafer, and create desired features.

The ion implantation process generally begins with the selection of the appropriate ion species and energy level. The ion species is chosen based on the desired doping effect, such as introducing impurities to create either n-type or p-type regions. The energy level determines the depth of ion penetration into the material. The ions used in the ion implantation process can be generated in an ion source, typically by ionizing a gas or solid material. These ions are then accelerated to high speeds using an electric field, forming an ion beam. The ion beam is subsequently directed towards the target material using magnetic fields, ensuring precise control over the ion implantation area. Prior to the ion implantation, the target material undergoes cleaning and surface treatment to eliminate contaminants and create a uniform surface. The wafer is then placed in a vacuum chamber, where it is bombarded by the ion beam. The ions penetrate the material's surface and come to rest at a specific depth, determined by the energy level.

During the ion implantation process, the ion beam can be carefully controlled to achieve the desired doping profile. This involves controlling the ion dose, which determines the concentration of implanted ions, and the implantation angle, which affects the lateral distribution of ions. Multiple implantation steps may be performed to achieve complex doping profiles.

However, while essential for creating desired doping profiles in semiconductor structures, this technique can also cause various structural damages in the material. As aforementioned, during ion implantation, ions are accelerated to high speeds using an electric field and then directed towards the target material. When these ions collide with the atoms in the target material, they transfer their kinetic energy, causing displacement of atoms from their lattice positions. This displacement can lead to distinct types of structural damage, including point defects, extended defects, lattice strain, etc.

Point defects refer to the presence of vacancies (missing atoms) or interstitials (extra atoms) in the crystal lattice. These defects can alter the electrical, optical, and mechanical properties of the material. For example, in silicon, the vacancies or interstitials created by ion implantation can affect the carrier concentration and mobility, leading to changes in the electrical conductivity of the material.

Another type of structural damage is the formation of extended defects, such as dislocations and stacking faults. Dislocations are line defects in the crystal lattice where the atomic arrangement is disrupted. Stacking faults occur when there is a deviation from the regular stacking sequence of atomic planes. These defects can affect the mechanical strength and reliability of the material. For instance, the dislocations created by ion implantation can function as sites for strain accumulation and crack initiation, reducing the material's mechanical integrity.

Moreover, it is possible that the lattice strain in the target material is induced by ion implantation. Lattice strain refers to the distortion of the crystal lattice due to the implantation of ions with different atomic sizes or crystal structures. This strain can lead to changes in the material's optical and electrical properties. For example, in gallium nitride (GaN), ion implantation can introduce strain that affects the bandgap energy and the emission wavelength of the material.

Subsequent to the ion implantation process in a semiconductor manufacturing process, the next step typically involves a thermal annealing process to activate the implanted ions and repair any damage caused during implantation. This process requires heating the wafer to a specific temperature for a certain duration of time.

During the thermal annealing process, the heat activates the implanted ions, allowing them to move and occupy lattice sites in the crystal structure of the semiconductor material. The elevated temperature during this process enables the atoms in the crystal lattice to move and rearrange, effectively healing any defects or dislocations created during implantation. The temperature and duration of the diffusion process depend on the desired depth and concentration of the diffused region. These parameters are controlled to achieve the desired electrical properties and functionality in the semiconductor device.

The diffusion process can be implemented to achieve specific functionality in the semiconductor device. For instance, when creating a pn junction in a diode, a diffusion process can introduce dopant atoms of a different type into the semiconductor material. This creates a region with a different concentration of dopants, resulting in the formation of a pn junction.

In some in comparative embodiments, Technology Computer Aided Designs (TCAD) tools can be employed to predict the outcome of the ion implantation process and subsequent thermal annealing. These tools can utilize physics-based models and computer simulations to quantitatively evaluate the properties of semiconductor devices, processes, and materials. By predicting experimental results or trends without the need for actual performance, they may reduce development cycles and save resources.

However, currently tools such as TCAD still have certain limitations in terms of their practical functionality. In typical TCAD implantation and recrystallization models, ion implantation is simulated using empirical models in a continuum mesh. However, these empirical models are unphysical and cannot accurately predict the distribution of damage under different process conditions, such as ion energy and implantation angle. Additionally, these models lack information about the substrate.

Furthermore, thermal annealing is simulated in an atomic mesh domain in the TCAD tools. However, the current methodology only considers surface atoms, resulting in a loss of information about damage in the bulk, such as defects and dislocations. In practice, accurately capturing the implantation-diffusion physics requires considering these defects and dislocations.

Moreover, the meshes used in the ion implantation and thermal annealing simulations are isolated from each other and cannot be coupled to form a unified simulation flow. This means that there is currently no available tool to simulate the full process.

A feasible atomic-level TCAD-based solution, including algorithms and models, is provided for simulating the ion implantation and diffusion process. This methodology can simulate the recipe of ion implantation and diffusion for any semiconductor device, regardless of its geometric structures and materials, without the need to conduct real experiments. The current recipe can be improved based on the simulation's outcome. This not only saves a significant amount of budget but also reduces time.

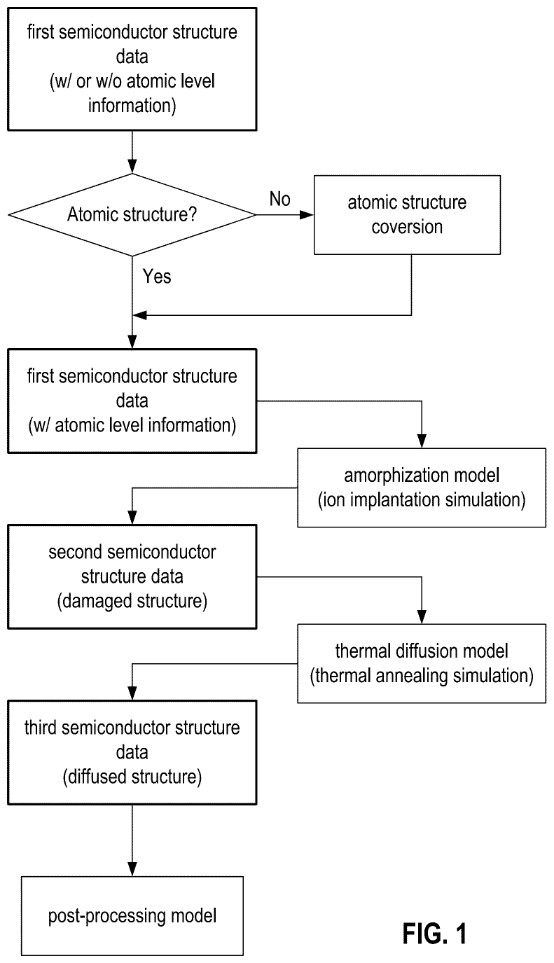

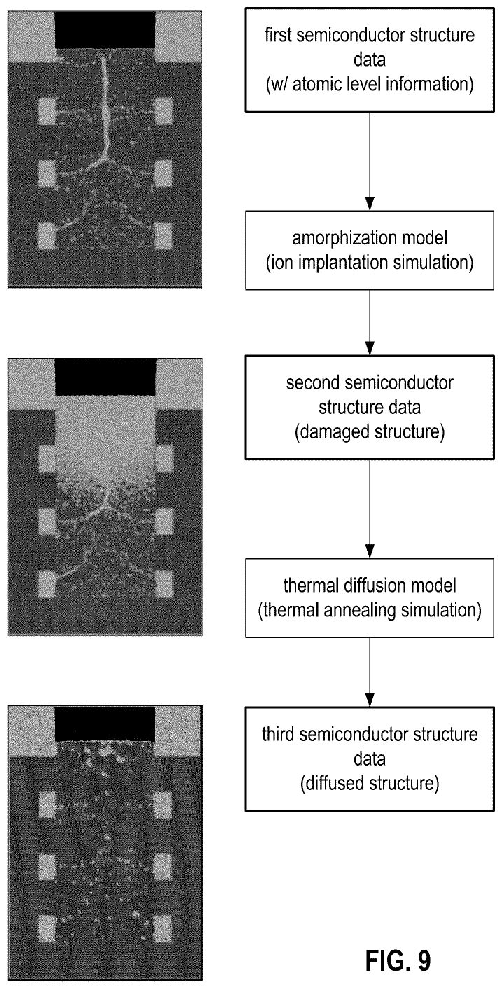

FIG. 1 illustrates the flow of simulating atomic structures in a semiconductor manufacturing process, particularly the simulations involving ion implantation and thermal annealing. As shown in FIG. 1, the semiconductor structure undergoes changes during the ion implantation and thermal annealing processes, resulting in a damaged structure and then a diffused structure. The semiconductor structure data in FIG. 1 (and also in FIG. 9) are outlined with thicker borders to emphasize variations in the content of the semiconductor structure data. The details regarding the execution of the simulation flow will be provided in subsequent embodiments.

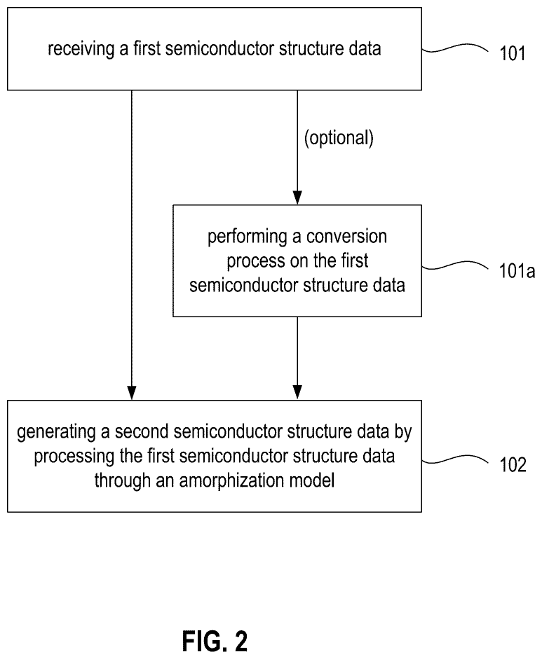

Referring to FIG. 2, which illustrates a flow chart of a method for simulating atomic structures in a semiconductor manufacturing process according to some embodiments of the present disclosure, which includes an operation 101: receiving a first semiconductor structure data; and an operation 102: generating a second semiconductor structure data by processing the first semiconductor structure data through an amorphization model. In some embodiments, the amorphization model is configured to perform a structure amorphization based on an expect atomic displacement of each atom in the semiconductor structure induced by a simulated ion implantation process. These operations are executed according to the instructions of one or more computing devices involved in the simulation process. In some embodiments, the one or more computing devices can be grouped and called a simulation system.

In some embodiments, the first semiconductor structure data includes the digital and quantitative information related to the semiconductor structure to be simulated. In some embodiments, the semiconductor structure to be simulated can be called initial structure since it is the structure at the very beginning of the simulation process. In other embodiments, in order to ensure that the information related to the semiconductor structure can be used by the algorithms and models employed in the present disclosure, one or more pre-conversion operations can be further preformed to obtain usable data formats or include the needed data content.

That is, in some embodiments, after a structure file is input into the computing devices, an examination process including the following operations can be performed: checking a level information of the first semiconductor structure data before generating the second semiconductor structure data; and performing a conversion process to the first semiconductor structure data if the first semiconductor structure data is free from having an atomic level information.

To be more detailed, in some embodiments of the present disclosure, the simulation is under the fact that the calculation includes all atoms in the semiconductor structure. This means that the results show not only the distribution of doped elements but also the impact on the spatial positions of all original atoms in the semiconductor structure due to ion implantation and/or thermal annealing. Therefore, simulating the semiconductor structure allows the user to understand both the distribution of doped elements and any potential structural effects that may occur, such as the vacancies or interstitials created by ion implantation process.

In some embodiments, the semiconductor structure to be simulated by the simulation system substantially refers to the region of interest (ROI) within a semiconductor structure, rather than encompassing the entire portion of a semiconductor device.

In the event that the first semiconductor structure data does not include atomic level information, the simulation system may become aware of this circumstance. The conversion process is then to be performed on the first semiconductor structure data to ensure the substantial initiation and continuity of the simulation (see an operation 101a illustrated in FIG. 2). In some embodiments, the atomic level information includes a coordinate and an atomic species of each atom in the semiconductor structure (to be simulated). In some embodiments, the atomic level information includes other material parameters such as lattice constant, which is related to the arrangement of atoms within a unit cell. In some embodiments, the atomic level information can be manually inputted, loaded from one or more databases, or generated by the simulation system.

In some alternative embodiments, the simulation system is designed in a simplified form without actively conducting checks on data formats or content. For instance, the simulation method it executes may simplistically assume that the input data includes atomic level information, and the simulation is not performed (e.g., automatically terminate the simulation process) once the data is easily determined to deviate from the default format. In some embodiments, a user interface (UI) may be employed to prompt the user to provide the atomic level information.

In the circumstances that the first semiconductor structure data does include atomic level information, the semiconductor data recited in the first semiconductor structure data can be seen as an initial structure for simulation, which means that the semiconductor structure is the structure just before an ion implantation process is performed.

As previously mentioned, in operation 102, the second semiconductor structure data can be generated by processing the first semiconductor structure data through the amorphization model. This operation is intended to illustrate the alteration of the initial structure of the semiconductor structure resulting from the ion implantation process, specifically, to illustrate how the initial structure is damaged by the ion implantation process. Thus, it can be referred to as a damaged structure accordingly.

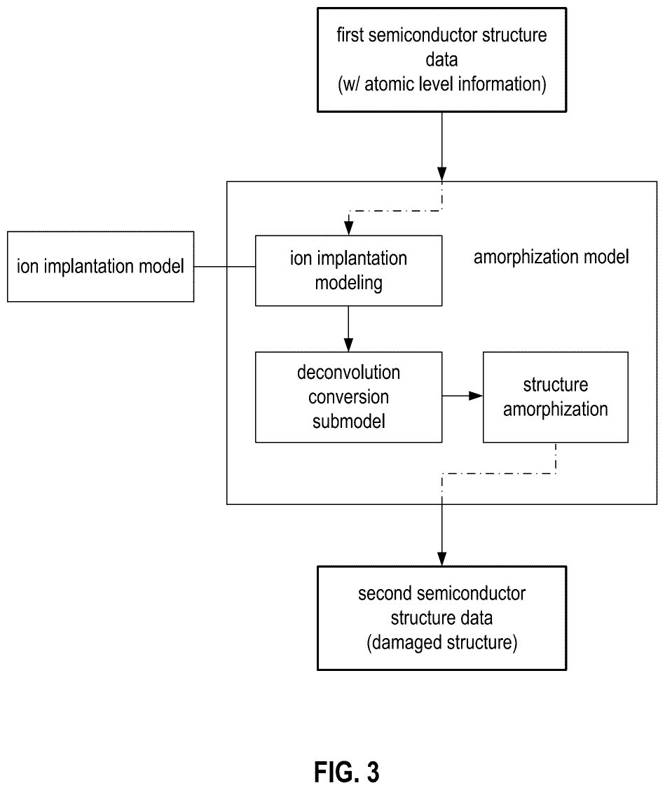

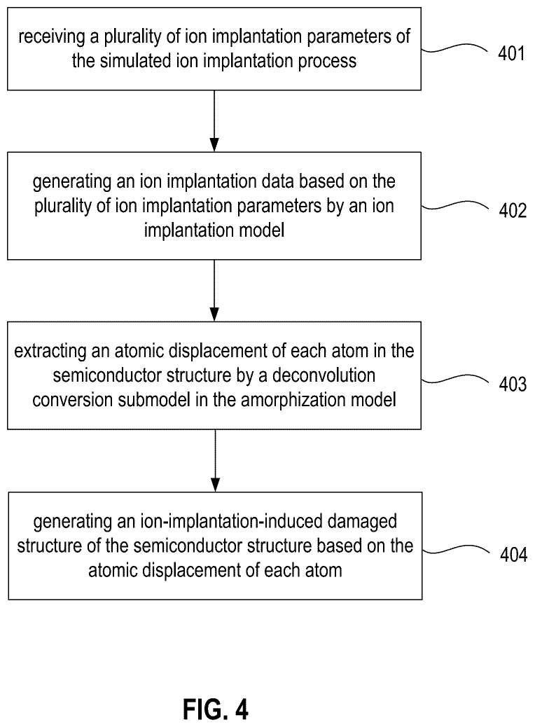

Referring to FIG. 3, which illustrates a flow of the work of the amorphization model and the architecture thereof. Furthermore, as shown in FIG. 4, which illustrates a flow chart of a process of generating the second semiconductor structure data by processing the first semiconductor structure data through an amorphization model according to some embodiments of the present disclosure, which includes an operation 401: receiving a plurality of ion implantation parameters of the simulated ion implantation process; an operation 402: generating an ion implantation data based on the plurality of ion implantation parameters by an ion implantation model; an operation 403: extracting an atomic displacement of each atom in the semiconductor structure by a deconvolution conversion submodel in the amorphization model; and an operation 404: generating an ion-implantation-induced damaged structure of the semiconductor structure based on the atomic displacement of each atom.

To provide more detail, during the amorphization process, the ion implantation parameters for the simulated ion implantation process are initially received (i.e., the operation 401).

In some embodiments, these ion implantation parameters may be provided by the user of the simulation system to a computational tool known as the Stopping and Range of Ions in Matter (SRIM) program to generate the ion implantation data (i.e., the operation 402). In some embodiments, the plurality of ion implantation parameters can include an ion species, an ion energy, an incident angle, a substrate material, and a dopant does. Generally, the ion implantation model, such as the SRIM program, can operate independently of the amorphization model, as illustrated in FIG. 4. Furthermore, since the content of the initial structure is not altered during the ion implantation modeling process, it is represented by a dot-dash line in FIG. 4 for this situation.

The SRIM program is a computer software package commonly utilized in the field of ion beam physics and materials science. It is utilized to simulate and analyze the interactions of energetic ions with matter, furnishing information on parameters such as stopping power, range, penetration depth, and others.

In some examples provided by the SRIM program, such as Germanium Preamorphization Implantation (Ge PAI), the SRIM program may generate dopant distribution (Pᵢₒₙ) and vacancy distribution (P_{recoil}) plots, each within an x-z plane. These plots can be used to illustrate the probability of dopants and vacancies distributed in the semiconductor structure from a cross-sectional view. The dopant distribution (Pᵢₒₙ) represents the probability of dopants in the simulated outcome of ion implantation, and the vacancy distribution (P_{recoil}) can be derived from the dopant distribution (Pᵢₒₙ) through a convolution method. However, the SRIM program cannot generate the ion-implantation-induced damaged structure of the semiconductor structure because it lacks information regarding the atomic displacement of each atom. Consequently, in some embodiments of the present disclosure, a deconvolution method is applied to deconvolute the vacancy distribution (P_{recoil}), which results from the convolution of the dopant distribution (Pᵢₒₙ). This process enables the reasonable atomic displacement of each dopant to be determined. More details of the SRIM program and the deconvolution method are described as follows.

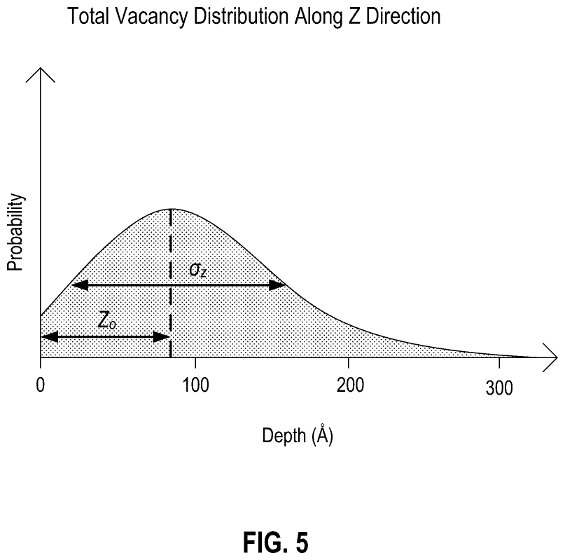

As shown in FIG. 5, in some embodiments, the distribution of vacancies is determined by the implantation parameters z₀ and σ_{z}, which denote the peak position of the z-distribution and half-width of the distribution, respectively. Generally, the SRIM program possesses some distinctive features, including its ab initio nature that eliminates the need for experimental data or empirical parameters. Moreover, it inherently accommodates all conceivable ion types, element species, and substrate materials. Additionally, the program intrinsically incorporates recoils, referring to atoms expelled from the lattice due to incident particles, thereby encompassing recoil cascades. However, the source of the ion implantation data in the present disclosure is not limited to being obtained solely from the SRIM program but can also include other computational tools with similar functions.

In the simulation of ion implantation processes, the SRIM program or similar computational tools, in some embodiments, can generate the ion implantation data, including an implantation depth, an implantation width, a recoil distribution, and an ion distribution. This is based on the plurality of ion implantation parameters inputted into the SRIM program.

Since the ion implantation data generated by the typical computational tools such as SRIM program cannot directly be mapped to atomic structure (i.e., the first semiconductor structure data that including atomic level information of the semiconductor structure), in some embodiments, the deconvolution conversion submodel in the amorphization model can be employed to converts the results from the SRIM program (i.e., the ion implantation data) to data consistent with atomic structure. In addition, because the approach in calculating the atomic displacement is a reverse process of convolution, thus the submodel performed thereby is called deconvolution conversion submodel in some embodiments of the present disclosure.

In some embodiments, the ion implantation data can be data consistent with atomic structure if the average atomic displacement during the ion implantation process is integrated into the ion implantation data. The average atomic displacement here refers to the average displacement of a target atom when colliding with the implanted ions.

In other words, the result from an ordinary ion implantation model (e.g., the SRIM program) cannot be directly used for structure amorphization due to the lack of information regarding atomic displacement. This implies that the ordinary ion implantation model does not provide knowledge about the average distance a crystalline atom travels during the ion implantation process. Therefore, in some embodiments of the present disclosure, as aforementioned, the deconvolution conversion submodel in the amorphization model is employed to convert the ion implantation results into atomic displacement (\vec{d}=(dₓ, d_{z})).

In order to convert the ion implantation results into atomic displacement, based on the dopant distribution (Pᵢₒₙ) and the vacancy distribution (P_{recoil}) obtained from the ion implantation model (e.g., the SRIM program), the deconvolution conversion submodel in the amorphization model has to make optimization on a cost function L based on the equation:

$$L ( \vec{r} ) = {P}_{recoil} ( \vec{r} ) - \int \int {P}_{i o n} ( \vec{{r}^{′}} ) \cdot N ( {d}_{x} , {d}_{z} , \vec{r} - \vec{{r}^{′}} ) {dr}^{′} + λ ( {d}_{x}^{2} + {d}_{z}^{2} ) .$$

P_{recoil} and Pᵢₒₙ are distributions from ion implantation modeling and is discretized on real space mesh grid ( [symbol] and [symbol] denotes grid position of integral). λ is a fitting parameter and a penalty term λ(dₓ²+d_{z}²) is to avoid over fitting of the optimization, and the value of λ is determined by cross-validation over grid data. In some scenarios, λ is within about 1E−4 to 1. N(dₓ, d_{z}, [symbol] − [symbol] ) is a 2D normal distribution function, with standard deviation of dₓ and d_{z}. In some embodiments, the extracted value of dₓ and d_{z} (i.e., the atomic displacement of each atom in the semiconductor structure) for 10 keV Ge implantation is about 2.0 Å to about 5.0 Å.

In the context of simulation, the cost function L is a mathematical expression that quantifies the disparity between predicted and actual outcomes. The primary objective is to minimize this cost function, reflecting a desire for more accurate predictions or better model performance. In some embodiments of the present disclosure, given that the simulation aims to predict the structural response of a material (e.g., each atom) subjected to external forces, the cost function could be formulated to evaluate the difference between the simulated displacements and the observed or desired displacements in response to those forces.

Once the parameters are extracted from the deconvolution conversion submodel, the atomic-level damaged structure can be generated through a process called structure amorphization. In other words, the amorphization model generates the damaged atomic structure using parameters extracted from the deconvolution conversion submodel. The stage of structure amorphization may introduce damages into a perfect lattice in a manner that satisfies three conditions: (1) the total number of damages dose equals the defect dose from experiments, (2) the damage distribution follows a Gaussian-like distribution, as verified by experiments, and (3) the displacement distribution aligns with the results from the conversion model.

In some embodiments, the damages can exhibit a Gaussian-like distribution:

$$p ( x , z ) = \frac{1}{A} \cdot f ( x , z ) = \frac{1}{A} \cdot {e}^{-} \frac{{( z - {z}_{0} )}^{2}}{2 {σ}_{z}^{2}} \cdot f ( x ) , f ( x ) = \{ \begin{matrix}{e}^{-} \frac{{( x - {x}_{0} )}^{2}}{2 {σ}_{x}^{2}} , xlo + 5. < x < xhi - 5. \\ \frac{{z}_{θ}}{5} ( x - xlo ) , x < xlo + 5. \\ - \frac{{z}_{θ}}{5} ( x - xhi ) , x > xhi - 5.\end{matrix} ,$$

where defects such as vacancy and interstitial atoms may have a Gaussian distribution along the z-direction, characterized by Gaussian parameters (z₀, σ_{z}). The x-direction adheres to a Gaussian-like distribution with Gaussian parameters (x₀, σₓ), and the defect distribution linearly decays to 0 at material boundaries. In some examples, it is configured as x₀=0 and

$${σ}_{x} = \frac{{x}_{h i} - {x}_{l o}}{2}$$

in the simulation, with its validity verified by experimental data. Here, xlo and xhi denote the x range of a region of interest (ROI). A is a normalization parameter calculated by

$$A = \frac{\int \int f ( x , z ) dxdz}{dose \cdot ( {x}_{h i} - {x}_{l o} )} ,$$

wherein

$${z}_{θ} = {e}^{-} \frac{{( x l o + 5.0 )}^{2}}{2 {σ}_{x}^{2}} .$$

After the atomic displacement dₓ and d_{z} are obtained through the deconvolution conversion submodel, the second semiconductor structure data, which includes the atomic level information of each vacancy and each interstitial atom in the semiconductor structure induced by the simulated ion implantation process, can be obtained accordingly through the structure amorphization.

In some embodiments, the second semiconductor structure data can be subsequently processed by an operation that generates a third semiconductor structure data. This is achieved by processing the second semiconductor structure data through the thermal diffusion model to obtain an expect atomic diffusion of each atom in the semiconductor structure in a simulated thermal annealing process. In other words, because ion implantation and thermal diffusion (or called annealing diffusion) are sequential steps in a typical semiconductor manufacturing process, the simulation, in some embodiments of the present disclosure, is also performed continuously to determine the diffused structure as an outcome of the simulation, rather than focusing solely on the damaged structure resulting from the ion implantation process.

In some embodiments, the thermal diffusion model is configured to perform a simulated thermal annealing process by applying a time-stamped force-bias Monte Carlo (tfMC) algorithm and based on of an information of each atom in the semiconductor structure.

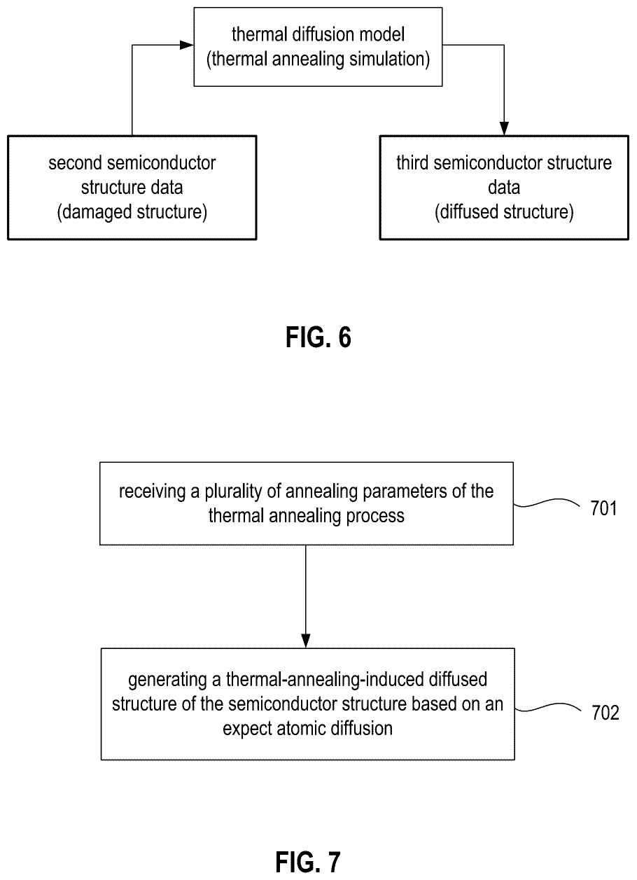

Referring to FIG. 6, which illustrates a flow of the work of the thermal diffusion model. Furthermore, as shown in FIG. 7, which illustrates a flow chart of a process of generating the third semiconductor structure data by processing the second semiconductor structure data through the thermal diffusion model according to some embodiments of the present disclosure, which includes an operation 701: receiving a plurality of annealing parameters of the thermal annealing process; and an operation 702: generating a thermal-annealing-induced diffused structure of the semiconductor structure based on an expect atomic diffusion.

In some embodiments, the plurality of annealing parameters includes an annealing temperature and an annealing time. Additionally, there is another annealing parameter, the interatomic potential, which may impact the diffusion outcome. However, since the interatomic potential constitutes a set of material-based internal parameters, this set of parameters does not require manual change or input.

In some comparative embodiments, a molecular dynamics (MD) model can be utilized to simulate thermal diffusion processes; however, the tfMC algorithm is two orders of magnitude faster than the MD method while maintaining acceptable accuracy. Given that the second semiconductor structure data includes atomic level information of the semiconductor structure, particularly, encompassing the coordinates and species of each atom, along with the coordinates of each defect in the semiconductor structure, the tfMC algorithm can be employed to expedite the thermal diffusion simulation process.

In some alternative embodiments, the thermal diffusion simulation process can be conducted based on the first semiconductor structure data instead of the second semiconductor structure data. In this scenario, if a semiconductor structure data provides sufficient atomic level information about the semiconductor structure, such as the coordinates and species of each atom, the simulation system in the present disclosure may directly process the first semiconductor structure data through the thermal diffusion model. In other words, while the semiconductor structure data in the present disclosure is capable of being used in both the amorphization model and the thermal diffusion model to obtain the damaged structure and the diffused structure, respectively, users still may have the flexibility to perform either simulation as needed. In cases where the first semiconductor structure data undergoes processing by the thermal diffusion model, an operation to check whether the first semiconductor structure data includes atomic level information would be performed before the simulation. Indeed, if the first semiconductor structure data is free from having atomic level information, the conversion process as previously mentioned should be performed.

In some embodiments, as previously shown in the flow in FIG. 1, after the third semiconductor structure data is obtained, which means the thermal diffusion simulation is complete, the third semiconductor structure data can be subsequently utilized by one or more post-processing models for additional simulations. In some embodiments, the post-processing model includes a stress model, a crystallinity model, or similar models tailored for specific simulations.

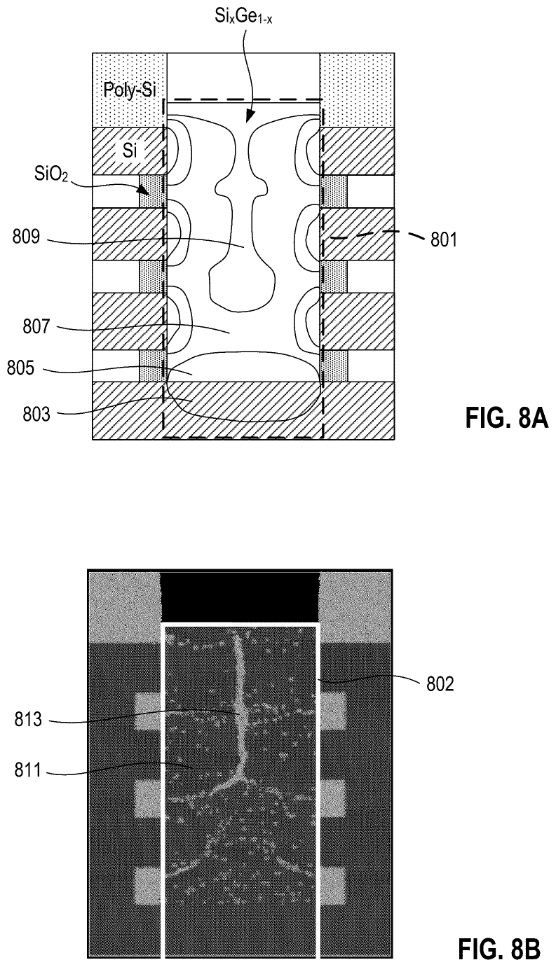

Referring to FIG. 8A, which illustrates schematic diagram of a semiconductor structure from a cross-sectional view perspective. In the example shown in FIG. 8A, the structure is formed during the epitaxial growth process in the fabrication of transistor structures, and there can have a multilayered configuration with varying concentrations of germanium. For instance, the layers 803, 805, 807, and 809 may include SiₓGe₁₋ₓ epitaxial structures, wherein x in these layers may be as 0 in layer 803, in a range from about 0.8 to about 0.95 in layer 805, in a range from about 0.3 to about 0.8 in layer 807, and in a range from about 0.2 to about 0.7 in layer 807. In order to perform the ion implantation and thermal annealing simulations in this disclosure on this structure, particularly, for example, a ROI 801 in FIG. 8A (and so does a ROI 802 in FIG. 8B, which may include the S/D region of the transistor structure), it is essential to ensure that the structure contains atomic level information. This includes details such as the compositional atomic components and the corresponding coordinates thereof, as shown in the digital simulation image example presented in FIG. 8B. In the example shown in FIG. 8B, distinct colors may represent whether the structure is crystal (e.g., a region 811), amorphous (e.g., a region 813), or contains defects, where defects could include situations involving dopants or dislocations, as exemplified in FIG. 8B and similar examples.

Referring to FIG. 9, which illustrates the digital simulation image examples to visually describe the difference between the first semiconductor structure data, the second semiconductor structure data, and the third semiconductor structure data under the models used in the present disclosure for simulating ion implantation and thermal annealing. In the scenario that the epitaxial S/D region is the ROI, and since the S/D epitaxial structure can be expected to introduce stress for channel but the defects or amorphous regions in the S/D epitaxial structure may reduce such stress, Ge-PAI annealing process can be used to increase the stress induced by the S/D epitaxial structure by reducing the volume of the amorphous regions and defects in the S/D epitaxial structure. By performing a simulation of Ge-PAI annealing process, as exemplified in the lower part of FIG. 9, there are less amorphous regions and defects can be seen in the S/D epitaxial structure, and the stress provided thereby can be increased accordingly.

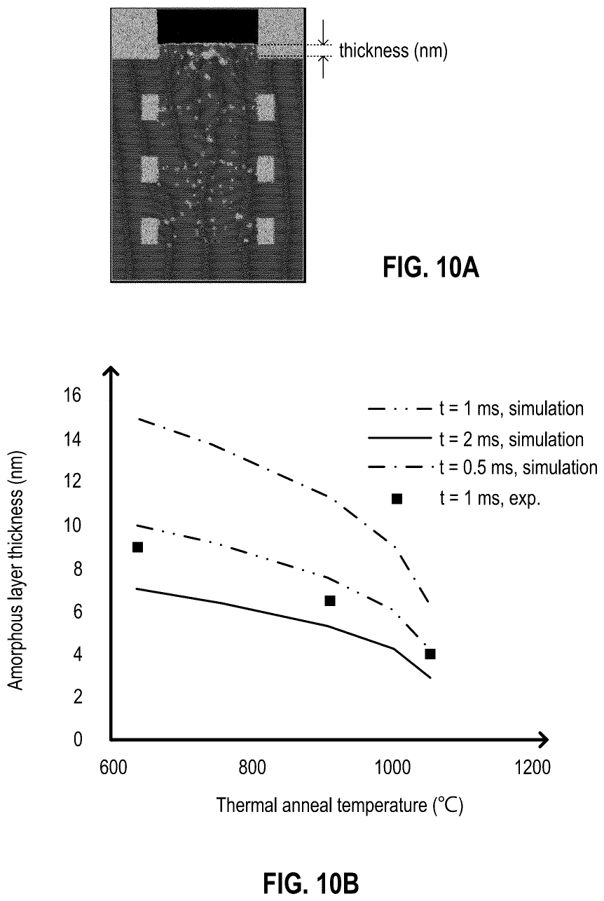

Referring to FIGS. 10A and 10B, in some examples, the thickness of the amorphous region in proximity to an upper portion of the S/D epitaxial structure (i.e., the distance between the maxima of crystallinity function along z-direction and a surface of the S/D epitaxial structure), such as the thickness labeled in FIG. 10A, can be altered based on the change of the parameters of thermal annealing. As illustrates in FIG. 10B, simulation data demonstrates comparable results to experimental data, leading to the conclusion that the thickness of the amorphous region decreases with increasing temperature. Fine-tuning the input parameters can yield more accurate results. That is, can be stated that a longer S/D annealing time and higher temperature result in improved crystallization.

Drawing insights from the examples, it is anticipated that the method in some embodiments of the present disclosure can provide guidance on implantation-annealing recipes. Moreover, the method in the present disclosure can be applied in all processes involving ion implantation and thermal annealing, or either of the two. Additionally, the method the present disclosure has the capability to simulate the recipe of implantation and diffusion for any device with diverse geometric structures and materials, eliminating the need for experiments. This not only saves costs but also reduces turnaround time.

In one exemplary aspect, a method for simulating atomic structures in a semiconductor manufacturing process is provided. The method includes the following operations. A first semiconductor structure data is received. A second semiconductor structure data is generated by processing the first semiconductor structure data through an amorphization model. The amorphization model is configured to perform a structure amorphization based on an expect atomic displacement of each atom in the semiconductor structure induced by a simulated ion implantation process.

In another exemplary aspect, a method for simulating atomic structures in a semiconductor manufacturing process is provided. The method includes the following operations. A first semiconductor structure data is received. The first semiconductor structure data comprises an atomic level information of each atom in a semiconductor structure. A second semiconductor structure data is generated by processing the first semiconductor structure data through a thermal diffusion model. The thermal diffusion model is configured to perform a simulated thermal annealing process by applying a time-stamped force-bias Monte Carlo (tfMC) algorithm and based on an atomic level information of each atom in the semiconductor structure.

In yet another exemplary aspect, a method for simulating atomic structures in a semiconductor process is provided. The method includes the following operations. A first semiconductor structure data is received. The first semiconductor structure data comprises an atomic level information of each atom in a semiconductor structure. A second semiconductor structure data is generated by processing the first semiconductor structure data to obtain an expect atomic displacement of each atom in the semiconductor structure in a simulated ion implantation process. A third semiconductor structure data is generated by processing the second semiconductor structure data to obtain an expect atomic diffusion of each atom in the semiconductor structure in a simulated thermal annealing process.

The foregoing outlines structures of several embodiments so that those skilled in the art may better understand the aspects of the present disclosure. Those skilled in the art should appreciate that they may readily use the present disclosure as a basis for designing or modifying other operations and structures for conducting the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for simulating atomic structures in a semiconductor manufacturing process, the method comprising:
receiving a first semiconductor structure data; and
generating a second semiconductor structure data by processing the first semiconductor structure data through an amorphization model, wherein the amorphization model is configured to perform a structure amorphization based on an expect atomic displacement of each atom in a semiconductor structure induced by a simulated ion implantation process.

2. The method of claim 1, wherein the first semiconductor structure data comprises an atomic level information of a semiconductor structure.

3. The method of claim 2, wherein the atomic level information comprises a coordinate and an atomic species of each atom in the semiconductor structure.

4. The method of claim 1, further comprising:
checking a level information of the first semiconductor structure data before generating the second semiconductor structure data; and
performing a conversion process to the first semiconductor structure data if the first semiconductor structure data is free from having an atomic level information.

5. The method of claim 1, wherein the operation of generating the second semiconductor structure data by processing the first semiconductor structure data through the amorphization model comprises:
receiving a plurality of ion implantation parameters of the simulated ion implantation process;
generating an ion implantation data based on the plurality of ion implantation parameters by an ion implantation model;
extracting an atomic displacement of each atom in the semiconductor structure by a deconvolution conversion submodel in the amorphization model; and
generating an ion-implantation-induced damaged structure of the semiconductor structure based on the atomic displacement of each atom.

6. The method of claim 5, wherein the plurality of ion implantation parameters comprises an ion species, an ion energy, an incident angle, a substrate material, and a dopant does.

7. The method of claim 5, wherein the ion implantation data comprises an implantation depth, an implantation width, a recoil distribution, and an ion distribution.

8. The method of claim 1, wherein the second semiconductor structure data comprises an atomic level information of each vacancy and each interstitial atom in the semiconductor structure induced by the simulated ion implantation process.

9. The method of claim 1, further comprising:
generating a third semiconductor structure data by processing the second semiconductor structure data through a thermal diffusion model.

10. A method for simulating atomic structures in a semiconductor manufacturing process, the method comprising:
receiving a first semiconductor structure data, wherein the first semiconductor structure data comprises an atomic level information of each atom in a semiconductor structure; and
generating a second semiconductor structure data by processing the first semiconductor structure data through a thermal diffusion model, wherein the thermal diffusion model is configured to perform a simulated thermal annealing process by applying a time-stamped force-bias Monte Carlo (tfMC) algorithm and based on an atomic level information of each atom in the semiconductor structure.

11. The method of claim 10, further comprising:
checking a level information of the first semiconductor structure data before generating the second semiconductor structure data; and
performing a conversion process to the first semiconductor structure data if the first semiconductor structure data is free from having the atomic level information.

12. The method of claim 10, further comprising:
generating a third semiconductor structure data by processing the first semiconductor structure data through an amorphization model prior to generating the second semiconductor structure data, wherein the amorphization model is configured to perform a structure amorphization based on an expect atomic displacement of each atom in the semiconductor structure induced by a simulated ion implantation process.

13. The method of claim 10, wherein the operation of generating the second semiconductor structure data by processing the first semiconductor structure data through the thermal diffusion model comprises:
receiving a plurality of annealing parameters of the thermal annealing process; and
generating a thermal-annealing-induced diffused structure of the semiconductor structure based on an expect atomic diffusion.

14. The method of claim 13, wherein the plurality of annealing parameters comprises an annealing temperature and an annealing time.

15. A method for simulating atomic structures in a semiconductor process, the method comprising:
receiving a first semiconductor structure data, wherein the first semiconductor structure data comprises an atomic level information of each atom in a semiconductor structure;
generating a second semiconductor structure data by processing the first semiconductor structure data to obtain an expect atomic displacement of each atom in the semiconductor structure in a simulated ion implantation process; and
generating a third semiconductor structure data by processing the second semiconductor structure data to obtain an expect atomic diffusion of each atom in the semiconductor structure in a simulated thermal annealing process.

16. The method of claim 15, wherein the atomic level information comprises a coordinate and an atomic species of each atom in the semiconductor structure.

17. The method of claim 15, wherein the operation of generating the second semiconductor structure data by processing the first semiconductor structure data comprises:
receiving a plurality of ion implantation parameters of the simulated ion implantation process;
generating an ion implantation data based on the plurality of ion implantation parameters by an ion implantation model;
extracting an atomic displacement of each atom in the semiconductor structure by a deconvolution conversion model; and
generating the second semiconductor structure data by mapping the atomic displacement of each atom to the first semiconductor structure data.

18. The method of claim 15, wherein the second semiconductor structure data comprises an atomic level information of each vacancy and each interstitial atom in the semiconductor structure induced by the simulated ion implantation process.

19. The method of claim 18, further comprising:
generating an altered semiconductor process recipe based on the third semiconductor structure data to decrease an amount of the vacancy and the interstitial atom in a region of interest (ROI) of the semiconductor structure.

20. The method of claim 15, wherein the simulated thermal annealing process is performed by applying a time-stamped force-bias Monte Carlo (tfMC) algorithm.
